(19) United States
(12) Patent Application Publication
(10) Pub. No.: US 2026/0006242 A1
(43) Pub. Date: Jan. 1, 2026

(54) METHOD AND APPARATUS FOR CODING MULTIMEDIA DATA, READABLE MEDIUM, AND ELECTRONIC DEVICE

(71) Applicant: Tencent Technology (Shenzhen) Company Limited, Shenzhen (CN)

(72) Inventor: Peihan ZHANG, Shenzhen (CN)

(73) Assignee: Tencent Technology (Shenzhen) Company Limited, Shenzhen (CN)

(21) Appl. No.: 19/321,902

(22) Filed: Sep. 8, 2025

Related U.S. Application Data
(63) Continuation of application No. PCT/CN2024/111501, filed on Aug. 12, 2024.

(30) Foreign Application Priority Data
Aug. 25, 2023 (CN) 202311095266.4

(51) Int. Cl. H04N 19/58; H04N 19/105; H04N 19/109; H04N 19/124; H04N 19/139; H04N 19/154; H04N 19/156; H04N 19/172; H04N 19/176; H04N 19/52

(52) U.S. Cl. CPC H04N 19/58; H04N 19/105; H04N 19/109; H04N 19/124; H04N 19/139; H04N 19/154; H04N 19/156; H04N 19/172; H04N 19/176; H04N 19/52

(57) ABSTRACT

A method, apparatus, and computer-readable storage medium for coding multimedia data with adaptive reference frame management. The method codes a current multimedia frame using a corresponding long-term reference frame to obtain a current coded multimedia frame. Coding quality is obtained for the long-term reference frame and calculated for the current coded multimedia frame. The type of the current coded multimedia frame is determined based on motion vectors of its coding blocks. The long-term reference frame is updated based on the coding quality of both frames and the frame type. Subsequent multimedia frames are then coded using the updated long-term reference frame, enabling improved coding efficiency through intelligent reference frame adaptation.

### CROSS-REFERENCE TO RELATED APPLICATIONS

This application is a continuation application of International Application No. PCT/CN2024/111501 filed on Aug. 12, 2024 which claims priority to Chinese Patent Application No. 202311095266.4, filed with the China National Intellectual Property Administration on Aug. 25, 2023, the disclosures of each being incorporated by reference herein in their entireties.

### FIELD

The disclosure relates to the field of multimedia technologies, a method and an apparatus for coding multimedia data, a computer-readable medium, and an electronic device.

### BACKGROUND

In the related art, to efficiently transmit video data, the video data is usually coded first, and then video coding data is transmitted. In a video coding process, to reduce a volume of the coded video data, the video data is usually disassembled into a plurality of frames, and then a difference between the frames is coded. Therefore, during coding, selection of a reference frame has important impact on quality of a coded video. During coding of a frame in a video, a video frame that is relatively close to the frame is selected as the reference frame. However, this coding manner has a problem of error propagation, leading to lower coding quality of a video frame in a coding process as the process proceeds. Therefore, the coding manner is to be improved.

### SUMMARY

Provided are a method and apparatus for coding multimedia data, a device, a storage medium, and a program product, which can implement efficient multimedia coding through adaptive long-term reference frame management based on coding quality and frame type analysis.

According to some embodiments, a method for coding multimedia data, performed by a computer device, includes: coding a current multimedia frame in multimedia data based on a long-term reference frame corresponding to the current multimedia frame, to obtain a current coded multimedia frame; obtaining coding quality of the long-term reference frame; calculating coding quality of the current coded multimedia frame; determining a type of the current coded multimedia frame based on a motion vector corresponding to a coding block in the current coded multimedia frame; and updating the long-term reference frame based on the coding quality of the current coded multimedia frame, the type of the current coded multimedia frame, and the coding quality of the long-term reference frame; and coding a subsequent multimedia frame in the multimedia data based on the updated long-term reference frame.

According to some embodiments, an apparatus for coding multimedia data, includes: at least one memory configured to store program code; and at least one processor configured to read the program code and operate as instructed by the program code, the program code including: coding code configured to cause at least one of the at least one processor to code a current multimedia frame in multimedia data based on a long-term reference frame corresponding to the current multimedia frame, to obtain a current coded multimedia frame; obtaining code configured to cause at least one of the at least one processor to obtain coding quality of the long-term reference frame; calculating code configured to cause at least one of the at least one processor to calculate coding quality of the current coded multimedia frame; determining code configured to cause at least one of the at least one processor to determine a type of the current coded multimedia frame based on a motion vector corresponding to a coding block in the current coded multimedia frame; and updating code configured to cause at least one of the at least one processor to update the long-term reference frame based on the coding quality of the current coded multimedia frame, the type of the current coded multimedia frame, and the coding quality of the long-term reference frame; and subsequent coding code configured to cause at least one of the at least one processor to code a subsequent multimedia frame in the multimedia data based on the updated long-term reference frame.

According to some embodiments, a non-transitory computer-readable storage medium, storing computer code which, when executed by at least one processor, causes the at least one processor to at least: code a current multimedia frame in multimedia data based on a long-term reference frame corresponding to the current multimedia frame, to obtain a current coded multimedia frame; obtain coding quality of the long-term reference frame; calculate coding quality of the current coded multimedia frame; determine a type of the current coded multimedia frame based on a motion vector corresponding to a coding block in the current coded multimedia frame; and update the long-term reference frame based on the coding quality of the current coded multimedia frame, the type of the current coded multimedia frame, and the coding quality of the long-term reference frame; and code a subsequent multimedia frame in the multimedia data based on the updated long-term reference frame.

In the technical solutions provided herein, after the current to-be-coded multimedia frame is coded, the coding quality of the long-term reference frame is obtained, the coding quality of the current coded multimedia frame is calculated, the type of the current coded multimedia frame is determined according to the motion vector corresponding to the coding block in the current coded multimedia frame, and the long-term reference frame is updated according to the coding quality of the current coded multimedia frame, the type of the current coded multimedia frame, and the coding quality of the long-term reference frame, thereby implementing dynamic adjustment of the long-term reference frame in the coding process of the multimedia data, avoiding that a fixed long-term reference frame cannot provide effective reference information for a multimedia frame far away, and improving the coding quality of the multimedia data. In addition, the long-term reference frame is updated based on the coding quality and the type of the multimedia frame, to ensure that the updated long-term reference frame is more appropriate and accurate, and further improve the coding quality of the multimedia data.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic block diagram of an exemplary system architecture to which a technical solution is applied.

FIG. 2 is a schematic flowchart of a method for coding multimedia data according to some embodiments.

FIG. 3 is a schematic flowchart of a method for coding multimedia data according to some embodiments.

FIG. 4 is a schematic diagram of a coding process of a multimedia frame.

FIG. 5 is a schematic flowchart of a method for coding multimedia data according to some embodiments.

FIG. 6 is a schematic diagram of a reference structure according to some embodiments.

FIG. 7 is a schematic diagram of a reference structure according to some embodiments.

FIG. 8 is a schematic flowchart of a method for coding multimedia data according to some embodiments.

FIG. 9 schematically shows a replacement process of a long-term reference frame to which a technical solution is applied.

FIG. 10 is a schematic structural block diagram of an apparatus for coding multimedia data according to some embodiments.

FIG. 11 is a schematic structural block diagram of a computer system of an electronic device suitable for implementing some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Exemplary embodiments are described more comprehensively with reference to the accompanying drawings. However, the exemplary embodiments can be implemented in a plurality of forms, and are not to be construed as being limited to examples described herein. On the contrary, these embodiments are provided such that this application is more comprehensive and complete, and fully conveys the concept of the exemplary embodiments to a person skilled in the art.

In addition, the described features, structures, or characteristics may be combined in one or more embodiments in any proper manner. In the following descriptions, many details are provided for comprehensive understanding of embodiments of the disclosure. However, a person skilled in the art is to be aware that the technical solutions in this application may be implemented without one or more of the details, or another method, unit, apparatus, or step may be used. In other cases, well-known methods, apparatuses, embodiments, or operations are not shown or described in detail, to avoid obscuring aspects of the disclosure.

The block diagrams shown in the accompanying drawings are merely functional entities and do not necessarily correspond to physically independent entities. These functional entities may be implemented in a software form, or these functional entities may be implemented in one or more hardware modules or integrated circuits, or these functional entities may be implemented in different networks and/or processor apparatuses and/or microcontroller apparatuses.

The flowcharts shown in the accompanying drawings are merely exemplary descriptions, do not may include all content and operations/steps, and do not may be performed in the described orders either. For example, some operations/steps may be further divided, while some operations/steps may be combined or partially combined. Therefore, an actual execution order may vary depending on an actual situation.

In some embodiments, in an involved step of determining a condition, a case in which a determining result is “equal to” may be classified into either of the determining result being “greater than” or the determining result being “less than” according to an actual requirement. “A plurality of” mentioned in the specification means two or more. The term “and/or” describes an association relationship between associated objects, and represents that three relationships may exist. For example, A and/or B may represent the following three cases: Only A exists, both A and B exist, and only B exists. The character “/” generally represents that associated objects in the context are in an “or” relationship.

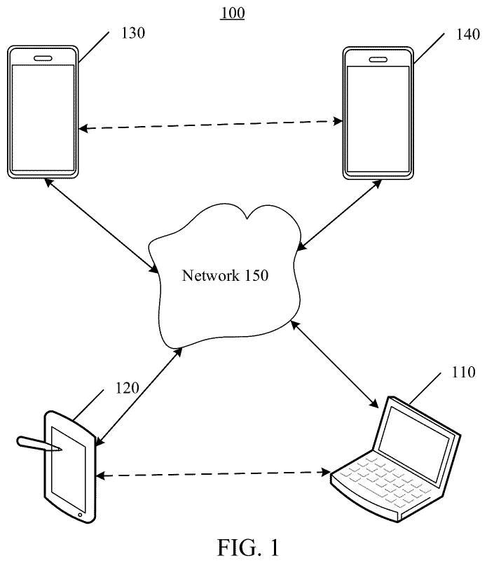

FIG. 1 is a schematic block diagram of an exemplary system architecture to which a technical solution of the disclosure is applied.

As shown in FIG. 1, a system architecture 100 includes a plurality of terminal apparatuses. The terminal apparatuses may communicate with each other through a network 150, for example. For example, the system architecture 100 may include a first terminal apparatus 110 and a second terminal apparatus 120 that are connected to each other through the network 150. In the embodiment of FIG. 1, the first terminal apparatus 110 and the second terminal apparatus 120 perform unidirectional data transmission.

For example, the first terminal apparatus 110 may code multimedia data (e.g., a video picture stream acquired by the first terminal apparatus 110) for transmission to the second terminal apparatus 120 through the network 150, coded multimedia data is transmitted in a form of one or more coded multimedia bitstreams, and the second terminal apparatus 120 may receive the coded multimedia data from the network 150, decode the coded multimedia data to restore the multimedia data, and display multimedia content according to the restored multimedia data. For example, using a low-delay live broadcast scenario as an example, the multimedia data is a video picture stream acquired by the first terminal apparatus 110, and is referred to as video data. The first terminal apparatus 110 codes the acquired video data according to the method for coding multimedia data provided in some embodiments, to generate coded video data, and transmits the coded video data to the second terminal apparatus 120 in a form of a bitstream through the network 150. The second terminal apparatus 120 receives a bitstream of the coded video data through the network 150, and decodes the received coded video data by using a decoding method corresponding to the coding method, so that the coded video data is restored to video data, and then the second terminal apparatus 120 plays or displays a corresponding video image based on the video data.

In some embodiments, the system architecture 100 may include a third terminal apparatus 130 and a fourth terminal apparatus 140 that perform bidirectional transmission of the coded multimedia data. The bidirectional transmission may, for example, occur during a video conference. For bidirectional data transmission, for example, the third terminal apparatus 130 can code the multimedia data (such as the acquired video picture stream) and transmit the coded multimedia data to the fourth terminal apparatus 140 through the network 150. The third terminal apparatus 130 may further receive the coded multimedia data transmitted by the fourth terminal apparatus 140, decode the coded multimedia data to restore the multimedia data, and display the multimedia content on an accessible display apparatus according to the restored multimedia data.

In the embodiment of FIG. 1, the first terminal apparatus 110, the second terminal apparatus 120, the third terminal apparatus 130, and the fourth terminal apparatus 140 may be servers, personal computers, and smartphones, but the principles disclosed in this application are not limited thereto. The embodiment disclosed in this application is adapted to a laptop computer, a tablet computer, a media player, and/or a dedicated video conference device. The network 150 represents any quantity of networks that include, for example, wired and/or wireless communication networks, and transmit the coded multimedia data between the first terminal apparatus 110, the second terminal apparatus 120, the third terminal apparatus 130, and the fourth terminal apparatus 140. The communication network 150 may exchange data in circuit-switched and/or packet-switched channels. The network may include a telecommunication network, a local area network, a wide area network, and/or the Internet. For the purposes of the disclosure, unless explained below, an architecture and topology of the network 150 may be immaterial to operations disclosed in this application.

The method for coding multimedia data provided in this application is described in detail below with reference to embodiments.

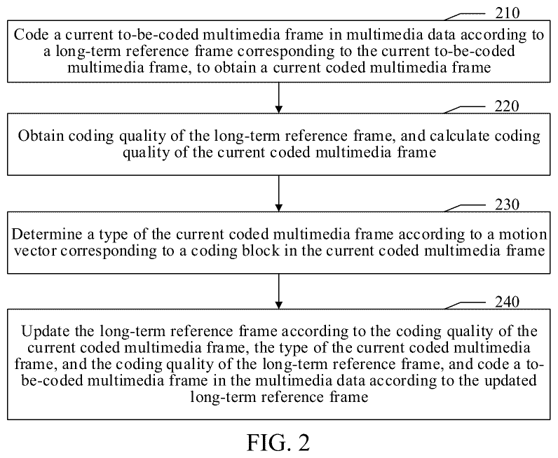

FIG. 2 is a schematic flowchart of a method for coding multimedia data according to some embodiments. The method may be implemented by an apparatus for coding multimedia data provided in some embodiments. The following describes a implementation process of the method by using the apparatus for coding multimedia data (which may be any one of the terminal apparatuses shown as an example in FIG. 1) as an execution body. As shown in FIG. 2, the method for coding multimedia data provided in some embodiments includes operations 210 to 240, which are as follows.

Operation 210: Code a current to-be-coded multimedia frame in multimedia data according to a long-term reference frame corresponding to the current to-be-coded multimedia frame, to obtain a current coded multimedia frame.

The multimedia data is data formed by a series of multimedia frames. For example, video data is data formed by a series of video frames. To code the multimedia data, generally, each multimedia frame is sequentially coded according to a time sequence of the multimedia frames in the multimedia data, and to code one multimedia frame, a corresponding reference frame may be obtained. The long-term reference frame is a multimedia frame that is used as a reference frame and that is fixed during a coding process. The long-term reference frame is a multimedia frame with a large amount of reserved information. For example, the long-term reference frame is a key frame in the multimedia data. The apparatus for coding multimedia data designates the long-term reference frame before coding the current to-be-coded multimedia frame. During coding, the apparatus may perform coding according to a difference between the current to-be-coded multimedia frame and the long-term reference frame. After being coded, the current to-be-coded multimedia frame becomes the current coded multimedia frame.

In some embodiments, the reference frame during coding of the multimedia frame includes the long-term reference frame and a short-term reference frame. The short-term reference frame is a multimedia frame that varies with a position of the current to-be-coded multimedia frame. The short-term reference frame is also referred to as a common reference frame. Before the multimedia data is coded, a total quantity of the reference frames and a quantity of the long-term reference frames of the multimedia data in the coding process may be set. The total quantity of the reference frames is a sum of the quantity of the long-term reference frames and a quantity of the short-term reference frames, and may also be referred to as a maximum quantity of reference frames. The quantity of the short-term reference frames may be obtained according to a difference between the total quantity of the reference frames and the quantity of the long-term reference frames. During coding, the long-term reference frame is obtained according to the quantity of the long-term reference frames. A multimedia frame used as the long-term reference frame has a identifier, and which multimedia frame is the long-term reference frame may be determined by identifying the identifier. In addition, the short-term reference frame is obtained according to the quantity of the short-term reference frames. Generally, the short-term reference frame is a coded multimedia frame closest to the current to-be-coded multimedia frame. Finally, the current to-be-coded multimedia frame is coded according to the long-term reference frame and the short-term reference frame. For example, it is assumed that the total quantity of the reference frames is 3, and the quantity of the long-term reference frames is 1, the long-term reference frame is the first frame. If the current to-be-coded multimedia frame is a t^{th} frame, corresponding short-term reference frames are a (t−1)^{th} frame and a (t−2)^{th} frame. After the t^{th} frame is coded, a (t+1)^{th} frame continues to be coded. Short-term reference frames corresponding to the (t+1)^{th} frame are the coded t^{th} frame and the (t−1)^{th} frame. If the long-term reference frame is not updated in this case, the long-term reference frame is still the first frame.

In some embodiments, the apparatus for coding multimedia data may record a reference frame in a coding process by using a reference frame list. The reference frame may be divided into a long-term reference frame list and a short-term reference frame list. The long-term reference frame list records an identifier of the long-term reference frame, and the short-term reference frame list records an identifier of the short-term reference frame. During coding, a corresponding reference frame may be determined by querying the reference frame list. The reference frame list is updated with the coding process. Only the reference frame may be recorded, and a multimedia frame identifier that is not the reference frame is moved out of the list. For example, in the foregoing example, during coding of the t^{th} frame, the short-term reference frame list records short-term reference frames, including the (t−1)^{th} frame and the (t−2)^{th} frame. During coding of the (t+1)^{th} frame, the (t−2)^{th} frame is moved out of the short-term reference frame list, and then the t^{th} frame is added to the list, so that the short-term reference frames recorded in the short-term reference frame list are the t^{th} frame and the (t−1)^{th} frame.

Operation 220: Obtain coding quality of the long-term reference frame, and calculate coding quality of the current coded multimedia frame.

During coding, the apparatus for coding multimedia data may divide the multimedia frame into a plurality of coding blocks, and then code each coding block. A method of calculating the coding quality of the current coded multimedia frame is the same as a method of calculating the coding quality of the long-term reference frame, and the coding quality of the multimedia frame may be calculated based on coding quality of the coding block included in the multimedia frame.

In some embodiments, in the coding process, after coding each multimedia frame, the apparatus for coding multimedia data calculates coding quality of the multimedia frame and stores or records the coding quality. During calculating of the coding quality of the current coded multimedia frame, the coding quality of the long-term reference frame is already calculated, and the coding quality of the long-term reference frame may be obtained from a corresponding storage or recording position without performing calculation again.

In some embodiments, after coding the coding block, the apparatus for coding multimedia data generates a coding cost value of the coding block, which may be referred to as a coding cost of the coding block. The coding cost of the coding block generally represents a difference between the coding block and a reference coding block, and the reference coding block is a coding block in a reference frame. Therefore, the coding cost of the coding block may also represent the coding quality of the coding block. Generally, a lower coding cost of the coding block indicates higher coding quality of the coding block. A higher coding cost of the coding block indicates lower coding quality of the coding block. A coding cost of the current coded multimedia frame may be considered as a sum of coding costs of the coding blocks included in the current coded multimedia frame. Therefore, a smaller sum of the coding costs of the coding blocks indicates higher coding quality of the current coded multimedia frame. A larger sum of the coding costs of the coding blocks indicates lower coding quality of the current coded multimedia frame.

Operation 230: Determine a type of the current coded multimedia frame according to a motion vector corresponding to a coding block in the current coded multimedia frame.

There are two types of multimedia frames: a dynamic multimedia frame and a static multimedia frame. The dynamic multimedia frame refers to that content of the multimedia frame is dynamic content. For example, a multimedia frame corresponding to a moving object is generally a dynamic multimedia frame. The static multimedia frame refers to that content of the multimedia frame does not change greatly, and may be considered as static content. For example, a multimedia frame corresponding to fixed background information is generally a static multimedia frame. The motion vector of the coding block represents a motion characteristic of the coding block, and is also a reflection of a difference between the coding block and a coding block of the reference frame. Whether content represented by the coding block is motion content may be determined based on the motion vector corresponding to the coding block, and further, the type of the current coded multimedia frame may be determined.

In some embodiments, during determining of the type of the current coded multimedia frame, whether the current coded multimedia frame is the dynamic multimedia frame may be determined according to a quantity of coding blocks having the motion characteristic in the current coded multimedia frame. If the current coded multimedia frame is not the dynamic multimedia frame, it is determined that the current coded multimedia frame is the static multimedia frame. For example, if the quantity of coding blocks having the motion characteristic included in the current coded multimedia frame exceeds or reaches a threshold, it is considered that the current coded multimedia frame is the dynamic multimedia frame. If the quantity of coding blocks having the motion characteristic included in the current coded multimedia frame does not reach the threshold, it is considered that the current coded multimedia frame is the static multimedia frame.

Operation 240: Update the long-term reference frame according to the coding quality of the current coded multimedia frame, the type of the current coded multimedia frame, and the coding quality of the long-term reference frame, and code a to-be-coded multimedia frame in the multimedia data according to an updated long-term reference frame.

Different types of multimedia frames include different information, and the static multimedia frame includes more abundant information, and is more suitable for being used as the reference frame. Therefore, when updating the long-term reference frame, the apparatus for coding multimedia data may select the static multimedia frame as the long-term reference frame. In addition, considering importance of the reference frame in the coding process, the apparatus for coding multimedia data may select a multimedia frame having high coding quality as the reference frame. In other words, the apparatus for coding multimedia data determines whether the current coded multimedia frame is the static multimedia frame according to the type of the current coded multimedia frame, and if the current coded multimedia frame is the static multimedia frame, compares the coding quality of the current coded multimedia frame and the coding quality of the long-term reference frame. If the coding quality of the current coded multimedia frame is higher than the coding quality of the long-term reference frame, the long-term reference frame is updated. For example, the current coded multimedia frame may be used as the long-term reference frame. Subsequently, the to-be-coded multimedia frame in the multimedia data may be coded based on the updated long-term reference frame. An execution order of an operation of determining whether the current coded multimedia frame is the static multimedia frame and an operation of comparing the coding quality of the current coded multimedia frame and the coding quality of the long-term reference frame is not limited in some embodiments. For example, the type of the multimedia frame may be determined before the coding quality is compared, or the type of the multimedia frame may be determined after the coding quality is compared.

In the technical solutions provided in some embodiments, after the current to-be-coded multimedia frame is coded, the coding quality of the long-term reference frame is obtained, the coding quality of the current coded multimedia frame is calculated, the type of the current coded multimedia frame is determined according to the motion vector corresponding to the coding block in the current coded multimedia frame, and finally the long-term reference frame is updated according to the coding quality of the current coded multimedia frame, the type of the current coded multimedia frame, and the coding quality of the long-term reference frame, thereby implementing dynamic adjustment of the long-term reference frame in the coding process of the multimedia data, avoiding that a fixed long-term reference frame cannot provide effective reference information for a multimedia frame far away, and improving the coding quality of the multimedia data. In addition, the long-term reference frame is updated based on the coding quality and the type of the multimedia frame, to ensure that the updated long-term reference frame is more appropriate and accurate, and further improve the coding quality of the multimedia data.

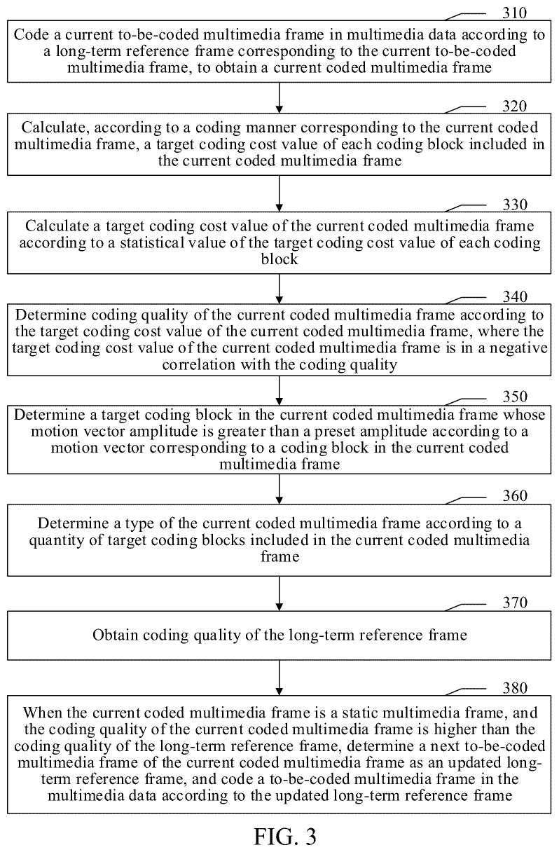

FIG. 3 is a schematic flowchart of a method for coding multimedia data according to some embodiments. This embodiment is a further refinement of the foregoing embodiments. As shown in FIG. 3, the method for coding multimedia data provided in some embodiments includes operations 310 to 380, which are as follows.

Operation 310: Code a current to-be-coded multimedia frame in multimedia data according to a long-term reference frame corresponding to the current to-be-coded multimedia frame, to obtain a current coded multimedia frame.

A process of coding the current to-be-coded multimedia frame in this operation is the same as operation 210 in the foregoing embodiment.

Operation 320: Calculate, according to a coding manner corresponding to the current coded multimedia frame, a target coding cost value of each coding block included in the current coded multimedia frame.

The coding manner is divided into two cases according to whether precoding is performed in a coding process: a first coding manner in which the precoding is performed, and a second coding manner in which the precoding is not performed. The precoding (lookahead) is to properly allocate a quantizer parameter of a discrete cosine change involved in the coding process of the multimedia frame. To increase a precoding speed, the multimedia data is scaled in a precoding process. For example, using video data as an example, the precoding is scaling down a width and height of a video image by one time. Assuming that an original size of the video image is 1920*1080, an image size during the precoding is 960*540, and the precoding (lookahead) is performing coding according to the image size 960*540. A coding cost obtained in the first coding manner in which the precoding is performed is different from a coding cost obtained in the second coding manner in which the precoding is not performed.

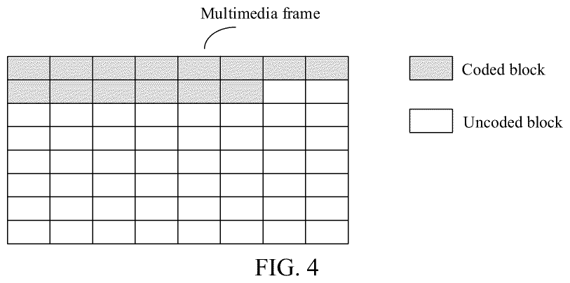

For example, FIG. 4 is a schematic diagram of a coding process of a multimedia frame. As shown in FIG. 4, during coding, the apparatus for coding multimedia data divides a multimedia frame into a plurality of coding blocks, and the coding block is also referred to as a macroblock. The apparatus for coding multimedia data sequentially codes the coding blocks in an order, to complete coding of a multimedia frame. For example, the apparatus for coding multimedia data sequentially codes the coding blocks in an order from left to right and from top to bottom.

In some embodiments, if precoding is not performed on a current coded multimedia frame in the coding process, a target coding cost value of the coding block is calculated according to an original coding cost value of the coding block. If the precoding is performed on the current coded multimedia frame in the coding process, a target coding cost value of the coding block is calculated according to the original coding cost value and a precoding cost value of the coding block. If the precoding is not performed during coding, after the coding block is coded, the coding block has an original coding cost value, and the target coding cost value is calculated according to the original coding cost value. If the precoding is performed during coding, after the coding block is coded, there are two coding cost values. One is the original coding cost value, and the other is the precoding cost value. Further, the target coding cost value may be calculated according to the two coding cost values.

A manner of calculating the original coding cost value of the coding block is not limited in some embodiments, nor is a manner of calculating the precoding cost value of the coding block. For example, the original coding cost value and the precoding cost value of the coding block may be calculated by using a sum of absolute difference (SAD) algorithm, or the original coding cost value and the precoding cost value of the coding block may be calculated by using a sum of absolute transformed difference algorithm. Calculation of the original coding cost value and the precoding cost value of the coding block by using the SAD algorithm is described below. Refer to the following formula (1) and formula (2).

$$P = {\sum }_{x = 0}^{m - 1} {\sum }_{y = 0}^{n - 1} \vert f ( x , y ) - g ( x , y ) \vert \qquad ( 1 )$$

$${P}^{′} = {\sum }_{x = 0}^{{m}^{′} - 1} {\sum }_{y = 0}^{{n}^{′} - 1} \vert h ( x , y ) - d ( x , y ) \vert \qquad ( 2 )$$

m and n in formula (1) may represent sizes of the coding block and a reference coding block. For example, the sizes of the coding block and the reference coding block are both 16*16. f(x, y) may represent a pixel value of the coding block at (x, y), g(x, y) may represent a pixel value of the reference coding block at (x, y), and P may represent the original coding cost value of the coding block. In other words, the original coding cost value is a value obtained by obtaining, after coding is performed on a video frame, an absolute difference between a pixel value of the coding block and a pixel value of the reference coding block at each pixel coordinate and adding the absolute differences for all pixels. Some embodiments does not limit a coding manner, for example, intra-frame DC prediction (“DC” represents a direct current component) or inter-frame SKIP prediction (SKIP represents skipping).

It can be known from the foregoing representation that the precoding includes two processes. The first process is scaling (for example, downsampling) the multimedia data, to obtain the scaled multimedia data, and the second process is coding the scaled multimedia data. Therefore, m′ and n′ in formula (2) may represent sizes of a scaled coding block and a scaled reference coding block. For example, if the sizes of the coding block and the reference coding block are both 16*16, and a scaling value is 2, the sizes of the scaled coding block and the scaled reference coding block are both 8*8, h(x, y) may represent a pixel value of the scaled coding block at (x, y), d(x, y) may represent a pixel value of the scaled reference coding block at (x, y), and P′ may represent the precoding cost value of the coding block. In other words, the precoding cost value is a value obtained by obtaining, after coding is performed on a video frame, an absolute difference between a pixel value of the scaled coding block and a pixel value of the scaled reference coding block at each pixel coordinate and adding the absolute differences for all pixels.

In conclusion, if the precoding is not performed during coding of the coding block, the original coding cost value of the coding block may be calculated by using formula (1). If the precoding is performed during coding of the coding block, the original coding cost value of the coding block may be calculated by using formula (1), and the precoding cost value of the coding block may be calculated by using formula (2).

In some embodiments, if the precoding is not performed during coding, when the target coding cost value is calculated, the original coding cost value of the coding block is multiplied by a quantizer parameter (a QP value) corresponding to the coding block, to obtain the target coding cost value of the coding block. In this process, the quantizer parameter is configured for further enlarging the original coding cost value of the coding block, to obtain a larger target coding cost value. Because the coding cost value actually reflects coding quality, the larger target coding cost value may enable a difference between multimedia frames of different coding quality to be more significant when the long-term reference frame is subsequently updated according to the coding quality, so that it is easier to select a multimedia frame with high coding quality. For example, assuming that an original coding cost value of a coding block 1 is 10, and an original coding cost value of a coding block 2 is 12, a difference between the two values is 2. The difference is small, and it may be considered that the two coding blocks have the same quality. If processing is performed by using the quantizer parameter, assuming that the quantizer parameter corresponding to the coding block 1 is 10, the target coding cost value of the coding block 1 is 100; and assuming that the quantizer parameter corresponding to the coding block 2 is 12, the target coding cost value of the coding block 2 is 144, and a difference between the two values is 44. It is clear that the difference increases, and it can be clearly recognized that coding quality of the coding block 1 and coding quality of the coding block 2 are different. Certainly, the quantizer parameter cannot be set to be excessively large either, the quantizer parameter is in a negative correlation with the coding quality, and an excessively large quantizer parameter causes degradation of the coding quality.

In some embodiments, if the precoding is performed during coding, when the target coding cost value is calculated, a candidate coding cost value is calculated according to the original coding cost value of the coding block. A manner of calculating the candidate coding cost value is the same as a manner of calculating the target coding cost value when the precoding is not performed. In other words, a product of the original coding cost value of the coding block and the quantizer parameter corresponding to the coding block is the candidate coding cost value. The precoding cost value of the coding block obtained based on the precoding is obtained, and then weighted summation is performed on the candidate coding cost value and the precoding cost value, to obtain the target coding cost value. When the weighted summation is performed on the two coding cost values, a weight of the candidate coding cost value is greater than a weight of the precoding cost value. For example, a value of the weight of the candidate coding cost value may be between 0.7 and 0.8, and a value of the weight of the precoding cost value may be between 0.2 and 0.3.

Operation 330: Calculate a target coding cost value of the current coded multimedia frame according to a statistical value of the target coding cost value of each coding block.

After the target coding cost value of each coding block included in the current coded multimedia frame is calculated, statistical calculation is performed on the target coding cost value of each coding block, to obtain the target coding cost value of the current coded multimedia frame. For example, a sum of the target coding cost values of the coding blocks is used as the target coding cost value of the current coded multimedia frame.

Operation 340: Determine coding quality of the current coded multimedia frame according to the target coding cost value of the current coded multimedia frame, where the target coding cost value of the current coded multimedia frame is in a negative correlation with the coding quality.

A mapping relationship between the target coding cost value and the coding quality may be pre-established, and then the coding quality of the current coded multimedia frame is determined by querying the mapping relationship. In some embodiments, the target coding cost value of the current coded multimedia frame may be directly used to represent the coding quality of the current coded multimedia frame. In this case, the target coding cost value is in a negative correlation with the coding quality.

Operation 350: Determine a target coding block in the current coded multimedia frame whose motion vector amplitude is greater than a preset amplitude according to the motion vector corresponding to the coding block in the current coded multimedia frame.

The target coding block is a coding block having a large motion amplitude, and the motion amplitude may be reflected by using a motion vector amplitude. Therefore, a motion vector amplitude of the coding block is calculated, and whether the coding block is the target coding block may be determined based on the motion vector amplitude. When the motion vector amplitude is greater than the preset amplitude, it is considered that the motion amplitude of the coding block is large, and is the target coding block. When the motion vector amplitude is less than the preset amplitude, it is considered that the motion amplitude of the coding block is small, and is not the target coding block. A case in which the motion vector amplitude is equal to the preset amplitude may be classified into either of the motion vector amplitude being greater than the preset amplitude or the motion vector amplitude being less than the preset amplitude. A classification may be set according to an actual requirement.

In some embodiments, when the multimedia frame is coded, each coding block of the multimedia frame may be coded by using two modes: inter-frame prediction and intra-frame prediction. The intra-frame prediction is predicting a current coding block by using a coding block in the same multimedia frame, and the inter-frame prediction is predicting a current coding block by using a coding block in another multimedia frame. In the coding process, a prediction mode with a small coding cost value is usually selected for coding. The intra-frame prediction does not involve coding between different multimedia frames, and the inter-frame prediction may reflect a change between different multimedia frames. Therefore, a coding block using an intra-frame prediction mode usually does not have a motion vector, and a coding block using an inter-frame prediction mode has a motion vector. Therefore, during determining of the target coding block, coding blocks using the inter-frame prediction mode may be first determined, the coding blocks using the inter-frame prediction mode are used as candidate coding blocks, and then motion vector amplitudes of the candidate coding blocks are calculated. When the motion vector amplitude of the candidate coding block is greater than the preset amplitude, the candidate coding block is the target coding block.

In some embodiments, a quantity of motion vectors of the coding blocks using the inter-frame prediction mode varies according to a size of a predicted pixel range. Generally, when the predicted pixel range is the same as a pixel range of the coding block, the candidate coding block has a motion vector. When the predicted pixel range is smaller than the pixel range of the coding block, the quantity of motion vectors of the candidate coding blocks is greater than 1. For example, assuming that a pixel range of a coding block is P16*16 (which represents that the coding block includes 16*16 pixels), and if a predicted pixel range is P16*16, the coding block includes one motion vector. If the predicted pixel range is P8*8, the coding block includes four motion vectors.

When a candidate coding block has a plurality of motion vectors, whether the candidate coding block is the target coding block is determined by determining whether a largest value of motion vector amplitudes of the candidate coding block is greater than the preset amplitude. When the largest value of the motion vector amplitudes of the candidate coding block is greater than the preset amplitude, the candidate coding block may be considered as the target coding block. When the largest value of the motion vector amplitudes of the candidate coding block is less than the preset amplitude, it is considered that the candidate coding block is not the target coding block.

Operation 360: Determine a type of the current coded multimedia frame according to a quantity of the target coding blocks included in the current coded multimedia frame.

A multimedia frame may include a plurality of target coding blocks, and a type of the multimedia frame may be reflected by the quantity of target coding blocks included in the multimedia frame. If the quantity of the target coding blocks is large, it represents that most content of the multimedia frame is moving, and it may be considered that the multimedia frame is a dynamic multimedia frame. If the quantity of the target coding blocks is small, it represents that there is little motion content of the multimedia frame, and it may be considered that the multimedia frame is a static multimedia frame. Therefore, the quantity of the target coding blocks included in the current coded multimedia frame may be compared with the preset threshold. If the quantity of the target coding blocks included in the current coded multimedia frame is greater than the preset threshold, it is considered that the current coded multimedia frame is the dynamic multimedia frame; and if the quantity of the target coding blocks included in the current coded multimedia frame is less than or equal to the preset threshold, it is considered that the current coded multimedia frame is the static multimedia frame.

In some embodiments, a process of determining the type of the current coded multimedia frame includes: calculating a ratio of the quantity of the target coding blocks included in the current coded multimedia frame to a total quantity of the coding blocks included in the current coded multimedia frame; when the ratio is less than or equal to a preset threshold, determining that the current coded multimedia frame is the static multimedia frame; or when the ratio is greater than a preset threshold, determining that the current coded multimedia frame is the dynamic multimedia frame.

The apparatus for coding multimedia data may determine the type of the current coded multimedia frame by using a proportion of the target coding blocks included in the current coded multimedia frame. The ratio of the quantity of the target coding blocks included in the current coded multimedia frame to a total quantity of the coding blocks included in the current coded multimedia frame is the proportion of the target coding blocks included in the current coded multimedia frame. When the ratio is less than or equal to the preset threshold, it indicates that the quantity of the target coding blocks is small, and therefore, it is considered that the current coded multimedia frame is the static multimedia frame. When the ratio is greater than the preset threshold, it indicates that the quantity of the target coding blocks is large, and therefore, it is considered that the current coded multimedia frame is the dynamic multimedia frame.

Operation 370: Obtain coding quality of the long-term reference frame.

A manner of obtaining the coding quality of the long-term reference frame in this operation is the same as the manner of obtaining or calculating the coding quality of the long-term reference frame in operation 220 in the foregoing embodiment.

Operation 380: When the current coded multimedia frame is the static multimedia frame, and the coding quality of the current coded multimedia frame is higher than the coding quality of the long-term reference frame, determine a next to-be-coded multimedia frame of the current coded multimedia frame as an updated long-term reference frame, and code a to-be-coded multimedia frame in the multimedia data according to an updated long-term reference frame.

When the current coded multimedia frame is the static multimedia frame, and the coding quality of the current coded multimedia frame is higher than the coding quality of the long-term reference frame, it indicates that a multimedia frame with better coding quality already occurs. In this case, the long-term reference frame may be updated based on the multimedia frame with better coding quality. If the target coding cost value is used to represent the coding quality, the target coding cost value of the current coded multimedia frame is less than the target coding cost value of the long-term reference frame, which represents that the coding quality of the current coded multimedia frame is higher than the coding quality of the long-term reference frame.

The coding process of the multimedia data includes two parts. One is a coding process of a syntax element, and the other is the coding process of the multimedia data. The syntax element and coded data of the multimedia data jointly form coded bitstream data. Each multimedia frame of the multimedia data has a corresponding syntax element. The syntax element of the multimedia frame includes description information of the multimedia frame. For example, the syntax element may include whether the multimedia frame is set to the long-term reference frame, identification information of the multimedia frame, and the like. Whether a multimedia frame can be used as the long-term reference frame may be determined according to content of a syntax element corresponding to the multimedia frame. However, in the coding process, the coding process of the syntax element is earlier than the coding process of the multimedia data. In other words, a syntax element of a multimedia frame is first written into a bitstream, and coded data of the multimedia frame is then written into the bitstream. Therefore, when the current coded multimedia frame is obtained, the syntax element of the current coded multimedia frame has been written into the bitstream, and cannot be changed. For example, the current coded multimedia frame can no longer be used as the long-term reference frame. However, in the multimedia data, a similarity between content included in two adjacent multimedia frames is generally high, especially in the static multimedia frame. Therefore, it may be considered that a next to-be-coded multimedia frame that has not been coded in this case has coding quality and a type that are the same as those of the current coded multimedia frame. Therefore, when the long-term reference frame is updated, the next to-be-coded multimedia frame that has not been coded may be used as the updated long-term reference frame, and subsequently, the to-be-coded multimedia frame in the multimedia data is coded according to the updated long-term reference frame.

When a subsequent to-be-coded multimedia frame in the multimedia data is coded, because the next to-be-coded multimedia frame is already used as the updated long-term reference frame, the multimedia frame is usually not used as the reference frame for coding. Therefore, a long-term reference frame corresponding to the next to-be-coded multimedia frame is still the long-term reference frame before the update, and a long-term reference frame corresponding to a still next to-be-coded multimedia frame is the updated long-term reference frame. For example, it is assumed that the current coded multimedia frame is a t^{th} frame, and the current long-term reference frame is a kth frame. If the t^{th} frame is the static multimedia frame, and coding quality of the t^{th} frame is higher than coding quality of the kth frame, a (t+1)^{th} frame is used as the updated long-term reference frame. When the (t+1)^{th} frame is coded, the kth frame is used as the long-term reference frame for coding. When a (k+2)^{th} frame and subsequent frames are coded, the (t+1)^{th} frame is used as the long-term reference frame for coding.

In the technical solutions provided herein, coding quality of the current to-be-coded multimedia frame is calculated according to the target coding cost value of each coding block included in the current to-be-coded multimedia frame. In this way, the coding quality may be quantized, to improve accuracy of determining the coding quality. A type of the current to-be-coded multimedia frame is determined by calculating a quantity of target coding blocks in the current to-be-coded multimedia frame, so that the type of the multimedia frame is determined based on a coding block granularity, thereby improving accuracy of determining the type of the multimedia frame. When the current coded multimedia frame is the static multimedia frame, and the coding quality of the current coded multimedia frame is higher than the coding quality of the long-term reference frame, the next to-be-coded multimedia frame of the current coded multimedia frame is used as the updated long-term reference frame, to update the long-term reference frame by using a high-quality static multimedia frame, thereby effectively improving coding quality of a subsequent multimedia frame.

In some embodiments, the long-term reference frame may be updated periodically. A process is: when a quantity of the current coded frames reaches a preset frame quantity, performing a zeroing operation on the quantity of the current coded frames; and updating the long-term reference frame according to the coding quality of the current coded multimedia frame, the type of the current coded multimedia frame, and the coding quality of the long-term reference frame, where the preset frame quantity is an integer and is less than a total quantity of multimedia frames included in a multimedia frame group in which the current to-be-coded multimedia frame is located.

The multimedia data may be divided into a plurality of multimedia frame groups, and a multimedia frame group includes a plurality of multimedia frames. When the multimedia data is coded, the multimedia frames in each multimedia frame group are coded in sequence by using the multimedia frame group as a unit. Therefore, the periodic update of the long-term reference frame is performed in a coding process of a multimedia frame group, and an update period of the long-term reference frame cannot exceed a time length of the multimedia frame group either. Then, the preset frame quantity is an integer greater than zero and is less than the total quantity of the multimedia frames included in the multimedia frame group in which the current to-be-coded multimedia frame is located.

Because a quantity of the multimedia frames included in the multimedia frame group can be determined, whether the update period of the long-term reference frame is reached may be determined according to the quantity of the current coded frames. The quantity of the current coded frames is a quantity of multimedia frames that have been coded at a current moment. When the quantity of the current coded frames reaches the preset frame quantity, it indicates that the update period has been reached. In this case, the long-term reference frame may be updated based on the coding quality and the type of the multimedia frame. For updating the long-term reference frame, a new long-term reference frame is not necessarily generated. When the coding quality and the type of the multimedia frame do not meet requirements, an original long-term reference frame is kept unchanged for this update. When the update period is reached, the zeroing operation is performed on the quantity of the current coded frames, so as to count a next update period. For example, the preset frame quantity is 5, the current coded multimedia frame is the 5^{th} frame and is the static multimedia frame, and the long-term reference frame is the Oth frame. If the quantity of the current coded frames has reached 5, coding quality of the 5^{th} frame and coding quality of the Oth frame are compared. If the coding quality of the 5^{th} frame is higher than the coding quality of the 0^{th} frame, the 6^{th} frame is used as the new long-term reference frame, and in the next update period, coding quality of the 11^{th} frame and coding quality of the 6^{th} frame are compared, to update the long-term reference frame. If the coding quality of the 5^{th} frame is lower than the coding quality of the Oth frame, the Oth frame is kept unchanged as the long-term reference frame. In the next update period, coding quality of the 10^{th} frame and the coding quality of the Oth frame are compared, to update the long-term reference frame.

The technical solutions of this application implement an objective of updating the long-term reference frame every preset frame quantity. The periodic update can reduce calculation resources consumed by updating the long-term reference frame when quality of the long-term reference frame may be ensured.

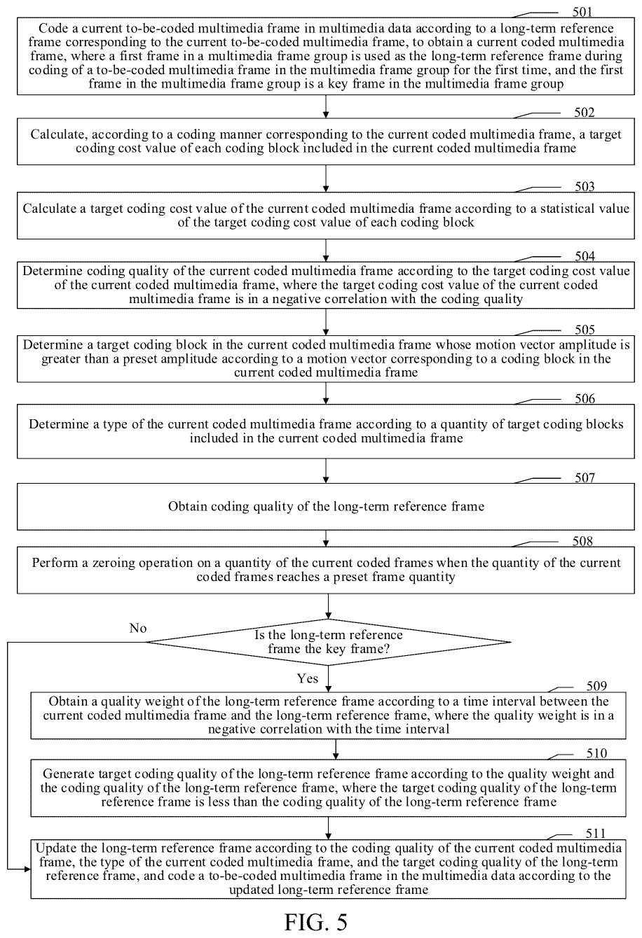

FIG. 5 is a schematic flowchart of a method for coding multimedia data according to some embodiments. This embodiment is a further refinement of the foregoing embodiments. As shown in FIG. 5, the method for coding multimedia data provided in some embodiments includes operations 501 to 511, which are as follows:

Operation 501: Code a current to-be-coded multimedia frame in multimedia data according to a long-term reference frame corresponding to the current to-be-coded multimedia frame, to obtain a current coded multimedia frame. The first frame in a multimedia frame group is determined as the long-term reference frame during coding a to-be-coded multimedia frame in the multimedia frame group for the first time, where the first frame in the multimedia frame group is a key frame in the multimedia frame group.

A process of coding the current to-be-coded multimedia frame in this operation is the same as operation 210 in the foregoing embodiment, and details are not described herein again.

In some embodiments, the multimedia frames in the multimedia data are in a form of the multimedia frame group, one multimedia frame group includes a plurality of multimedia frames, and one multimedia frame group represents one piece of continuous multimedia content. For example, the multimedia data is video data, a video frame group in the video data is also referred to as a group of pictures (GOP), a GOP includes a plurality of video frames, and a GOP represents a continuous video picture. During coding, division is performed by using the multimedia frame group as a unit. Different multimedia frame groups correspond to different long-term reference frames. Therefore, the apparatus for coding multimedia data may obtain a corresponding long-term reference frame according to a multimedia frame group in which the current to-be-coded multimedia frame is located for coding.

An example in which the multimedia data is the video data is used. There are three types of video frames: an I frame, a P frame, and a B frame. The I frame represents a key frame, and the I frame refers to only a part that has been coded during coding. The P frame represents a difference frame, and represents a difference between a current frame and a coded frame. The P frame refers to only a frame that is earlier in time domain and that has been coded during coding. The B frame represents a bidirectional difference frame, and represents a difference between a current frame and a previous frame and a next frame. During coding, the B frame may refer to a frame that is earlier in time domain, or may refer to a frame that is later in time domain, provided that it may be ensured that a referred frame is a frame that has been coded.

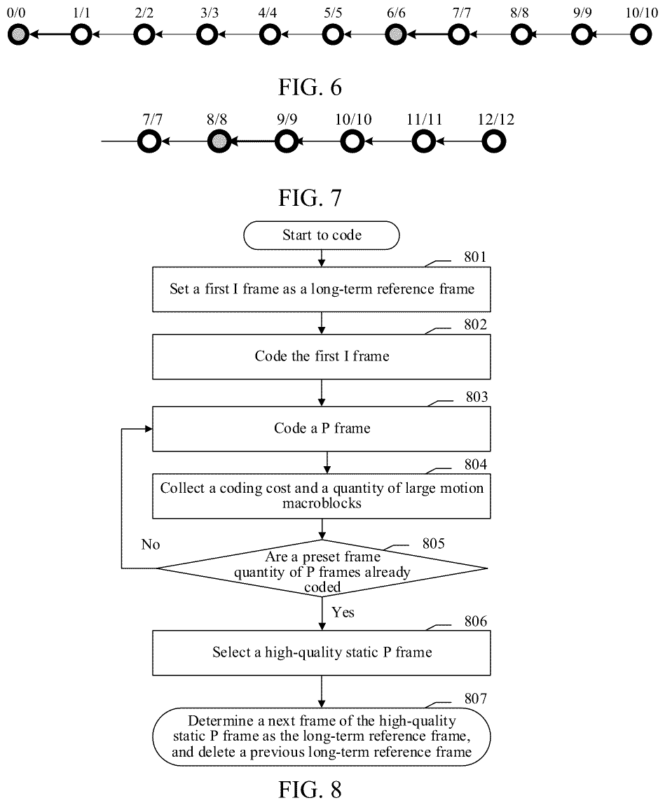

The key frame is usually a frame whose retained information is the most complete and whose quality is the highest in various multimedia frames. Therefore, in some embodiments, a key frame in each multimedia frame group is first set as a long-term reference frame of the multimedia frame group. When a multimedia frame in a multimedia frame group is coded for the first time, the obtained long-term reference frame is the first frame of the multimedia frame group, and the first frame is the key frame. For example, in a reference structure shown in FIG. 6, when reference is made to another frame that has been coded, a quantity of reference frames selected and a distance between the reference frame and the current coded frame may be considered as a reference structure. It is assumed that a total quantity of the reference frames is 2, there is one long-term reference frame, and the key frame is the 0/0^{th} frame. After the key frame is fixed as the long-term reference frame, if the 7/7^{th} frame is currently coded, the 7/7^{th} frame is coded with reference to the 0/0^{th} frame and the 6/6^{th} frame.

Operation 502: Calculate, according to a coding manner corresponding to the current coded multimedia frame, a target coding cost value of each coding block included in the current coded multimedia frame.

Operation 503: Calculate a target coding cost value of the current coded multimedia frame according to a statistical value of the target coding cost value of each coding block.

Operation 504: Determine the coding quality of the current coded multimedia frame according to the target coding cost value of the current coded multimedia frame, where the target coding cost value of the current coded multimedia frame is in a negative correlation with the coding quality.

Operation 505: Determine a target coding block in the current coded multimedia frame whose motion vector amplitude is greater than a preset amplitude according to the motion vector corresponding to the coding block in the current coded multimedia frame.

Operation 506: Determine a type of the current coded multimedia frame according to a quantity of the target coding blocks included in the current coded multimedia frame.

Operation 507: Obtain coding quality of the long-term reference frame.

Operations 502 to 507 are the same as operations 320 to 370 in the foregoing embodiments. Details are not described herein.

Operation 508: Perform a zeroing operation on a quantity of the current coded frames when the quantity of the current coded frames reaches a preset frame quantity.

For operation 508, refer to the descriptions for periodically updating the long-term reference frame in the foregoing embodiment. If the quantity of the current coded frames does not reach the preset frame quantity, coding is continued, and no long-term reference frame is updated.

Operation 509: Obtain a quality weight of the long-term reference frame according to a time interval between the current coded multimedia frame and the long-term reference frame when the long-term reference frame is the key frame, where the quality weight is in a negative correlation with the time interval.

Considering that the key frame is usually a frame with highest coding quality in a multimedia frame group, to avoid that the long-term reference frame cannot be updated because coding quality of a subsequent multimedia frame is always lower than the key frame, when the long-term reference frame is the key frame, a quality weight is assigned to the key frame, so that coding quality of the key frame matches a current moment. Although the key frame is a frame in the multimedia frame group whose retained information is the most complete, as time moves, a frame farther from the key frame is in a smaller correlation with the key frame. In other words, it is difficult for the key frame to provide effective reference information for a remote multimedia frame. Therefore, the quality weight of the key frame is obtained according to the time interval between the current coded multimedia frame and the current long-term reference frame (for example, the key frame), the quality weight is in a negative correlation with the time interval, and the quality weight falls within a range of (0, 1). For example, the multimedia frame group has 24 multimedia frames in total. If the current coded multimedia frame is the 4^{th} frame, the quality weight may be set to 0.8. If the current coded multimedia frame is the 8^{th} frame, the quality weight may be set to 0.6. If the current coded multimedia frame is the 12^{th} frame, the quality weight may be set to 0.4. If the current coded multimedia frame is the 16^{th} frame, the quality weight may be set to 0.2.

If the long-term reference frame is not the key frame, operation 511 is directly performed.

Operation 510: Generate target coding quality of the long-term reference frame according to the quality weight and the coding quality of the long-term reference frame, where the target coding quality of the long-term reference frame is lower than the coding quality of the long-term reference frame.

The quality weight is multiplied by the coding quality of the current long-term reference frame (for example, the key frame), to obtain the target coding quality of the current long-term reference frame. Because the quality weight is less than 1, the target coding quality of the long-term reference frame is lower than the coding quality of the long-term reference frame. Assuming that the coding quality of the key frame is 100, and the quality weight is 0.8, the target coding quality of the key frame is 80.

Operation 511: Update the long-term reference frame according to the coding quality of the current coded multimedia frame, the type of the current coded multimedia frame, and the target coding quality of the long-term reference frame, and code a to-be-coded multimedia frame in the multimedia data according to the updated long-term reference frame.

Operation 511 is the same as operation 380 in the foregoing embodiment. If the long-term reference frame is not the key frame, the target coding quality of the long-term reference frame is the same as the coding quality of the long-term reference frame.

For example, using the example in FIG. 6 as an example, the current long-term reference frame is the 0/0^{th} frame of the key frame, and the current coded multimedia frame is the 7/7^{th} frame. It is assumed that the 7/7^{th} frame is the static multimedia frame, coding quality of the 7/7^{th} frame is 90, and coding quality of the 0/0^{th} frame is 100. If a quality weight is not assigned to the key frame, in this case, the coding quality of the 7/7^{th} frame is lower than the coding quality of the 0/0^{th} frame, and a new long-term reference frame cannot be generated. If the quality weight assigned to the key frame is 0.8, target coding quality of the 0/0^{th} frame is 80. In this case, the coding quality of the 7/7^{th} frame is greater than the coding quality of the 0/0^{th} frame, and the 8/8^{th} frame may be used as the updated long-term reference frame. Subsequently, when the 9/9^{th} frame is coded, the 7/7^{th} frame is used as the long-term reference frame, and an updated reference structure is shown in FIG. 7.

In the technical solutions provided herein, the key frame in the multimedia frame group is set as the long-term reference frame, and during updating, a quality weight that is in a negative correlation with time is assigned to the key frame, to avoid that the long-term reference frame cannot be updated because coding quality of a subsequent multimedia frame cannot be higher than the coding quality of the key frame, thereby improving accuracy of updating the long-term reference frame.

FIG. 8 is a schematic flowchart of a method for coding multimedia data according to some embodiments. In this embodiment, a low-delay live broadcast scenario in which video compression is performed by using an H264 coding protocol is used as an example. The multimedia data is video data. One video includes a plurality of GOPs, one GOP includes at least one I frame, and the remaining frames may be P frames or B frames. For example, if the GOP is 24, and a frame rate of a current video is 24 fps, an I frame exists every one second, and 23 P frames or B frames exist between two I frames. For a low-delay live broadcast video, one GOP includes only an I frame and a P frame. If the GOP is 24, one GOP includes one I frame and 23 P frames.

As shown in FIG. 8, the method for coding multimedia data provided in some embodiments includes the following operations.

Operation 801: Set the first I frame as a long-term reference frame. In other words, the first I frame in the GOP is set as the long-term reference frame. In an H264 coding standard, an I frame includes a syntax element “long_term_reference_flag”. The syntax element is configured for indicating whether a long-term reference frame mechanism is used. When long_term_reference_flag is 0, it indicates that the long-term reference frame mechanism is disabled. When long_term_reference_flag is 1, it indicates that the long-term reference frame mechanism is enabled, and the I frame automatically becomes the long-term reference frame. In a coding process, long_term_reference_flag is set to 1, and is written into a coded bitstream, so that the I frame becomes the long-term reference frame.

Operation 802: Code the first I frame. Coding of the I frame refers to only a part that has been coded.

Operation 803: Code a P frame. Coding of the P frame refers to the long-term reference frame and a short-term reference frame. The short-term reference frame is one or more frames closest to the P frame. When the P frame is coded for the first time, the long-term reference frame is the I frame. If a maximum quantity of reference frames is 2, and a t^{th} frame is being coded currently, in addition to a (t−1)^{th} frame, a reference frame of the t^{th} frame further includes the 1^{st} frame (sometimes also recorded as the 0^{th} frame), for example, an I frame, in a current GOP. Coding quality of the I frame is higher than that of the P frame. Therefore, compared with reference to the (t−1)^{th} frame and a (t−2)^{th} frame, coding quality of the t^{th} frame with reference to the I frame and the (t−1)^{th} frame is generally higher.

Operation 804: Count a coding cost and a quantity of large motion macroblocks.

In the coding process, the coding cost is calculated in different manners according to whether precoding (lookahead) is enabled. In the coding process, an encoder divides a coded frame into a plurality of coding blocks, which are referred to as macroblocks. The encoder sequentially codes the macroblocks in an order from left to right and from top to bottom. For example, refer to FIG. 4. After each macroblock is coded, a corresponding original coding cost is obtained, and the original coding cost is multiplied by a quantizer parameter configured for coding the macroblock, to obtain a target coding cost of the macroblock. If the precoding (lookahead) is disabled, a sum of target coding costs of all macroblocks of a coded frame is calculated, for example, a target coding cost of the coded frame. If the precoding (lookahead) is enabled, in addition to collecting the coding cost (used as a first coding cost) of disabling the precoding (lookahead), a precoding cost of a coded frame obtained during the precoding (lookahead) further may be collected, the precoding cost of the coded frame obtained during the precoding (lookahead) is denoted as α, and the first coding cost of the coded frame obtained by disabling the precoding (lookahead) is denoted as β. A target coding cost γ of a coded frame is obtained by performing weighted calculation on α and β. The target coding cost of the coded frame may reflect the coding quality to some extent. Generally, a lower coding cost indicates better coding quality. This manner of determining the coding quality is relatively simple, includes only several operations of multiplication and addition, does not may perform additional time-consuming processing, and does not significantly increase calculation power.

A quantity of large motion macroblocks is configured for determining whether the coded frame is a static video frame. Generally, quality of the static video frame is higher than that of a dynamic video frame, and the static video frame has more abundant information that may be configured for reference. In the coding process, inter-frame prediction and intra-frame prediction may be performed on a macroblock, and a prediction manner with a low coding cost is selected. For a macroblock on which the inter-frame prediction is selected, the macroblock has one or more motion vectors configured for pointing to an area selected as a reference in the reference frame. An amplitude of each motion vector of the macroblock is collected, and a threshold TH_MV is set. If a largest value in the amplitudes of the motion vectors of the macroblock exceeds TH_MV, it is considered that the macroblock is a large motion macroblock.

Operation 805: Determine whether a preset frame quantity of P frames are already coded. In other words, the coding quality is compared every preset frame quantity, and a coded frame with highest quality is selected. The preset frame quantity actually represents a gap frame quantity between two adjacent coding quality comparison operations. Therefore, the preset frame quantity may be represented by Gap. The preset frame quantity Gap is an integer greater than 0, and a maximum value of the preset frame quantity Gap is less than a quantity of frames included in the GOP. If the preset frame quantity (Gap) of P frames have been coded, operation 806 is performed. If the preset frame quantity (Gap) of P frames have not been coded, operation 802 is performed to continue coding the P frames.

Operation 806: Select a high-quality static P frame.

The static P frame refers to that the P frame belongs to the static video frame. A percentage of the large motion macroblocks in the coded frame in the quantity of all the macroblocks is collected, and a threshold TH_P is set. If the percentage of the large motion macroblocks is less than TH_P, it is considered that the coded frame is a static video frame. Meanwhile, coding quality of the P frame is compared with coding quality of a current long-term reference frame, and a frame with higher quality is selected as an updated long-term reference frame. If the current long-term reference frame is the I frame, a quality weight may be assigned to the I frame, and then the coding quality of the I frame is compared with the coding quality of the P frame.

In some embodiments, to implement more accurate selection, the high-quality static P frame may be selected by using a machine learning model. A machine learning model may be constructed, a plurality of statistical characteristics of the coded frame are used as input parameters of the machine learning model, and the high-quality static P frame is selected by using the machine learning model.

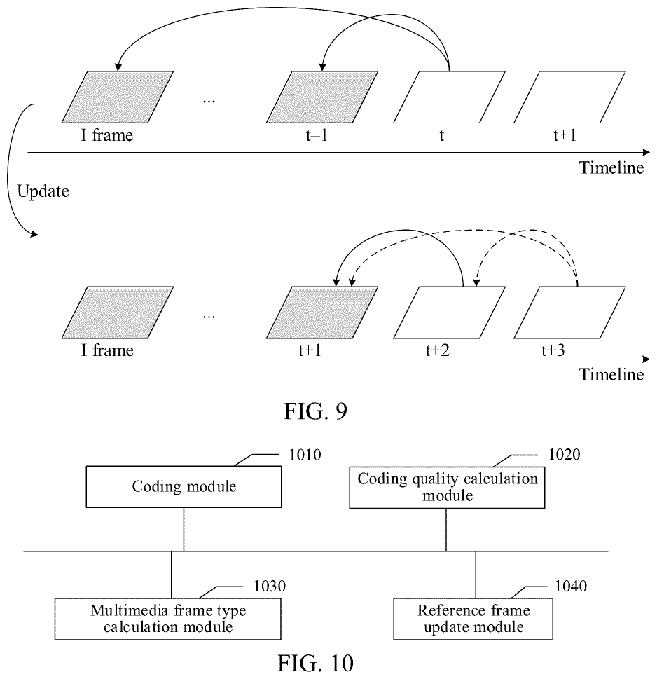

Operation 807: Determine a next frame of the high-quality static P frame as the long-term reference frame, and delete a previous long-term reference frame. Through the foregoing operations, the high-quality static P frame can be selected. Because a syntax element is written earlier than coding, the high-quality static P frame cannot be used as the long-term reference frame after the coding is completed. However, quality and content of two adjacent frames are extremely similar, especially for a static scene. Therefore, a next frame of the high-quality static P frame that has not started to be coded may be used as the long-term reference frame. A syntax element adaptive_ref_pic_marking_mode_flag included in the next frame (which is also the P frame) of the high-quality static P frame is labeled as 1, for example, the syntax element is allowed to be used as the long-term reference frame. Then, the P frame is set as the long-term reference frame in the bitstream by using the syntax element, and the I frame or the P frame initially used as the long-term reference frame is deleted from a reference frame queue. For example, FIG. 9 schematically shows a replacement process of a long-term reference frame to which the technical solution of the disclosure is applied. For the long-term reference frame, the I frame is replaced with a (t+1)^{th} frame.

In the technical solution of the disclosure, for a characteristic of a low-delay live broadcast video, for example, a characteristic that there are a large number of static scenes and the GOPs are short in length, an I frame with high quality is actively selected as a reference frame, to improve coding quality of a subsequent video frame. In addition, by analyzing a characteristic of a coded P frame, for example, quality of the P frame and video content of the P frame, a high-quality static P frame is selected as the reference frame, and the I frame used as the reference frame is replaced with the P frame, to provide a higher-quality reference for a subsequent P frame, thereby improving the coding quality of the subsequent video frame. Based on the foregoing two aspects, an H264 encoder can ensure that the reference frame always has high quality, thereby improving Bjontegaard Delta-rates (BD-rates) such as a peak signal-to-noise ratio (PSNR), structural similarity index measurement (SSIM), and video multimethod assessment fusion (VMAF) of a coded video sequence. The BD-rate is an index for evaluating performance of a video coding algorithm. A negative BD-rate represents that coding performance of an optimized algorithm is improved.

It is verified by an experiment that in a low-delay scenario, using the technical solution of the disclosure, average BD-rate gains corresponding to a PSNR, SSIM and VMAF of a test sequence coded by H264 are −0.35%, −0.4%, and −0.48%, respectively. The technical solution of the disclosure can effectively improve coding quality of video data without increasing a delay and without increasing a bit rate. In addition, operations in calculation process in this application are simple, and calculation power consumption is basically not increased.

Each step in the method in this application is described in an order in the accompanying drawings, however, this does not request or imply that the steps are necessarily performed in the order, or all shown steps are necessarily performed so as to achieve a desired result. In some embodiments, some steps may be omitted, a plurality of steps may be combined into one step for execution, and/or one step may be decomposed into a plurality of steps for execution, and the like.

Apparatus embodiments of the disclosure are described below, which may be configured for performing the method for coding multimedia data in the foregoing embodiment of the disclosure. FIG. 10 is a schematic structural block diagram of an apparatus for coding multimedia data according to some embodiments. As shown in FIG. 10, the apparatus for coding multimedia data provided in some embodiments includes:
a coding module 1010, configured to code a current to-be-coded multimedia frame in multimedia data according to a long-term reference frame corresponding to the current to-be-coded multimedia frame, to obtain a current coded multimedia frame;
a coding quality calculation module 1020, configured to: obtain coding quality of the long-term reference frame, and calculate coding quality of the current coded multimedia frame;
a multimedia frame type calculation module 1030, configured to determine a type of the current coded multimedia frame according to a motion vector corresponding to a coding block in the current coded multimedia frame; and
a reference frame update module 1040, configured to: update the long-term reference frame according to the coding quality of the current coded multimedia frame, the type of the current coded multimedia frame, and the coding quality of the long-term reference frame, and code a to-be-coded multimedia frame in the multimedia data according to the updated long-term reference frame.

In some embodiments, the coding quality calculation module 1020 includes:
a coding cost calculation unit, configured to calculate, according to a coding manner corresponding to the current coded multimedia frame, a target coding cost value of each coding block included in the current coded multimedia frame;
a statistical unit, configured to calculate a target coding cost value of the current coded multimedia frame according to a statistical value of the target coding cost value of each coding block; and
a quality calculation unit, configured to determine the coding quality of the current coded multimedia frame according to the target coding cost value of the current coded multimedia frame, the target coding cost value of the current coded multimedia frame being in a negative correlation with the coding quality.

In some embodiments, the coding cost calculation unit includes:
a first subunit, configured to: if precoding is not performed on the current coded multimedia frame in a coding process, calculate a target coding cost value of the coding block according to an original coding cost value of the coding block; and
a second subunit, configured to: if precoding is performed on the current coded multimedia frame in a coding process, calculate a target coding cost value of the coding block according to an original coding cost value of the coding block and a precoding cost value of the coding block.

In some embodiments, the first subunit is configured to:
multiply the original coding cost value of the coding block by a quantizer parameter corresponding to the coding block, to obtain the target coding cost value of the coding block, the quantizer parameter being configured for enlarging the original coding cost value of the coding block.

In some embodiments, the second subunit is configured to:
multiply the original coding cost value of the coding block by the quantizer parameter corresponding to the coding block, to obtain a candidate coding cost value of the coding block; and
perform weighted summation on the candidate coding cost value of the coding block and the precoding cost value of the coding block, to obtain the target coding cost value of the coding block, a weight of the candidate coding cost value being greater than a weight of the precoding cost value.

In some embodiments, the multimedia frame type calculation module 1030 includes:
a target coding block determining unit, configured to determine a target coding block in the current coded multimedia frame whose motion vector amplitude is greater than a preset amplitude according to the motion vector corresponding to the coding block in the current coded multimedia frame; and
a type determining unit, configured to determine a type of the current coded multimedia frame according to a quantity of target coding blocks included in the current coded multimedia frame.

In some embodiments, the target coding block determining unit is configured to:
extract a candidate coding block coded based on an inter-frame prediction mode from a plurality of coding blocks included in the current coded multimedia frame;
calculate an amplitude of a motion vector corresponding to the candidate coding block; and
when the amplitude of the motion vector corresponding to the candidate coding block is greater than the preset amplitude, determine that the candidate coding block belongs to the target coding block.

In some embodiments, the type determining unit is configured to:
calculate a ratio of the quantity of target coding blocks included in the current coded multimedia frame to a total quantity of coding blocks included in the current coded multimedia frame;
when the ratio is less than a preset threshold, determine that the current coded multimedia frame is a static multimedia frame; and
when the ratio is greater than a preset threshold, determine that the current coded multimedia frame is a dynamic multimedia frame.

In some embodiments, the reference frame update module 1040 is configured to:
determine a next to-be-coded multimedia frame of the current coded multimedia frame as the updated long-term reference frame when the current coded multimedia frame is the static multimedia frame, and the coding quality of the current coded multimedia frame is higher than the coding quality of the long-term reference frame.

In some embodiments, the multimedia data includes a plurality of multimedia frame groups; and the reference frame update module 1040 is configured to:
perform a zeroing operation on a quantity of current coded frames when the quantity of current coded frames reaches a preset frame quantity, and update the long-term reference frame according to the coding quality of the current coded multimedia frame, the type of the current coded multimedia frame, and the coding quality of the long-term reference frame,
the preset frame quantity being an integer and less than a total quantity of multimedia frames included in a multimedia frame group in which the current to-be-coded multimedia frame is located.

In some embodiments, the multimedia data includes a plurality of multimedia frame groups; and the apparatus further includes:
a key frame setting module, configured to determine the first frame in the multimedia frame group as the long-term reference frame during coding of a to-be-coded multimedia frame in the multimedia frame group for the first time, the first frame in the multimedia frame group being a key frame in the multimedia frame group.

In some embodiments, the reference frame update module 1040 is configured to:
obtain a quality weight of the long-term reference frame according to a time interval between the current coded multimedia frame and the long-term reference frame if the long-term reference frame is the key frame, the quality weight being in a negative correlation with the time interval;
generate target coding quality of the long-term reference frame according to the quality weight and the coding quality of the long-term reference frame, the target coding quality of the long-term reference frame being lower than the coding quality of the long-term reference frame; and
update the long-term reference frame according to the coding quality of the current coded multimedia frame, the type of the current coded multimedia frame, and the target coding quality of the long-term reference frame.

In some embodiments, the coding module 1010 is configured to:
obtain a quantity of short-term reference frames according to a difference between a total quantity of reference frames corresponding to the multimedia data and a quantity of long-term reference frames;
determine a multi-frame coded multimedia frame that is located before the current to-be-coded multimedia frame and that is corresponding to the quantity of the short-term reference frames as the short-term reference frame; and
code the current to-be-coded multimedia frame according to the short-term reference frame and the long-term reference frame.

Details of the apparatus for coding multimedia data provided herein are described in detail in the corresponding method embodiments, and are not described herein again.

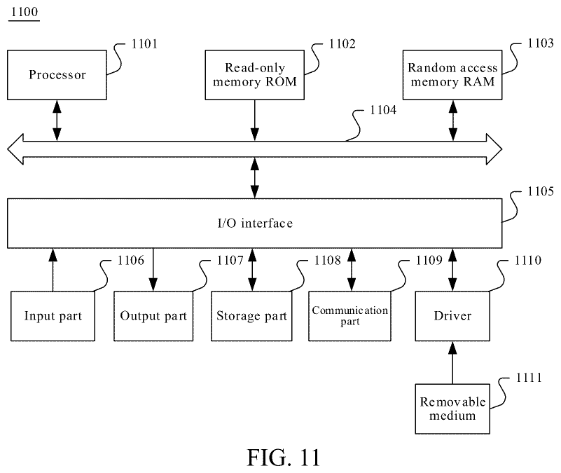

FIG. 11 is a schematic structural block diagram of a computer system of an electronic device for implementing some embodiments.

A computer system 1100 of the electronic device shown in FIG. 11 is merely an example, and does not constitute any limitation on functions and use ranges of some embodiments.

As shown in FIG. 11, the computer system 1100 includes a central processing unit (CPU) 1101, which may execute various proper actions and processing based on a program stored in a read-only memory (ROM) 1102 or a program loaded from a storage part 1108 into a random access memory (RAM) 1103. The random access memory 1103 further has various programs and data for system operation stored therein. The central processing unit 1101, the read-only memory 1102, and the random access memory 1103 are connected to each other via a bus 1104. An input/output (I/O) interface 1105 is also connected to the bus 1104.

The following components are connected to the input/output interface 1105: an input part 1106 including a keyboard, a mouse, and the like; an output part 1107 including a cathode ray tube (CRT), a liquid crystal display (LCD), a speaker, and the like; a storage part 1108 including a hard disk, and the like; and a communication part 1109 including a network interface card such as a local area network card or a modem. The communication part 1109 performs communication processing by using a network such as the Internet. A driver 1110 is also connected to the input/output interface 1105. A removable medium 1111, such as a magnetic disk, an optical disk, a magneto-optical disk, or a semiconductor memory, is mounted on the driver 1110, so that a computer program read therefrom is installed into the storage part 1108.

According to the some embodiments, the processes described in the various method flowcharts may be implemented as computer software programs. For example, some embodiments includes a computer program product, the computer program product includes a computer program carried on a computer-readable medium, and the computer program includes program code configured for performing the methods shown in the flowcharts. In such an embodiment, the computer program may be downloaded from a network through the communication part 1109 and installed, and/or installed from the removable medium 1111. When the computer program is executed by the central processing unit 1101, various functions defined in the system of the disclosure are performed.

The computer-readable medium shown in some embodiments may be a computer-readable signal medium or a computer-readable storage medium, or any combination of the two. The computer-readable storage medium may be, for example, but is not limited to, an electric, magnetic, optical, electromagnetic, infrared, or semiconductor system, apparatus, or device, or any combination of the above. More examples of the computer-readable storage media may include, but are not limited to, an electrical connection having one or more wires, a portable computer disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any suitable combination of the above. In this application, the computer-readable storage medium may be any tangible medium that includes or stores a program. The program may be used by or used in combination with an instruction execution system, apparatus, or device. Moreover, in this application, the computer-readable signal medium may include a data signal propagated in a baseband or as part of a carrier, and computer-readable program code is carried therein. A data signal propagated in such a way may assume a plurality of forms, including, but not limited to, an electromagnetic signal, an optical signal, or any suitable combination of the above. The computer-readable signal medium may, in some embodiments, be any computer-readable medium other than the computer-readable storage medium. The computer-readable medium may send, propagate, or transmit a program used by or in combination with an instruction execution system, apparatus, or device. The program code included in the computer-readable medium may be transmitted by using any suitable medium, including, but not limited to, a wireless medium, a wired medium, and the like, or any suitable combination of the above.

The flowcharts and block diagrams in the accompanying drawings illustrate possible system architectures, functions, and operations that may be implemented by a system, a method, and a computer program product according to some embodiments. In this regard, each box in the flowchart or the block diagram may represent a module, a program segment, or a part of code. The module, the program segment, or the part of code includes one or more executable instructions configured for implementing specified logic functions. In some embodiments, the functions labeled in the boxes may occur in an order different from that labeled in the accompanying drawings. For example, two boxes shown in succession can actually be executed substantially in parallel, or sometimes the two boxes may be performed in a reverse order. This is determined according to a related function. Each box in the block diagram or the flowchart and a combination of boxes in the block diagram or the flowchart may be implemented by a dedicated hardware-based system that performs a specified function or operation, or may be implemented by a combination of dedicated hardware and computer instructions.

Although several modules or units of a device configured to perform operations are mentioned in the above detailed descriptions, such division is not mandatory. Actually, according to some embodiments, features and functions of two or more modules or units described above may be implemented in one module or unit. On the contrary, the features and functions of one module or unit described above may be further divided and embodied by a plurality of modules or units.

Through the foregoing descriptions of the embodiments, a person skilled in the art may readily understand that the exemplary embodiments described herein may be implemented by software, or may be implemented by combining software with hardware. Therefore, the technical solutions of some embodiments may be implemented in a form of a software product. The software product may be stored in a non-volatile storage medium (which may be a CD-ROM, a universal serial bus (USB) flash drive, a removable hard disk, or the like) or on a network, including several instructions for instructing a computing device (which may be a personal computer, a server, a touch terminal, a network device, or the like) to perform the methods according to some embodiments.

A person skilled in the art can easily figure out other implementations of the disclosure after considering the description and practicing the disclosure that is disclosed herein. This application is intended to cover any variations, uses, or adaptive changes of the disclosure. These variations, uses, or adaptive changes follow the general principles of the disclosure and include common general knowledge or common technical means in the art, which are not disclosed in this application.

This application is not limited to the precise structures described above and shown in the drawings, and various modifications and changes may be made without departing from the scope of the disclosure. The scope of the disclosure is only limited to the appended claims.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for coding multimedia data, performed by a computer device, and the method comprising:
coding a current multimedia frame in multimedia data based on a long-term reference frame corresponding to the current multimedia frame, to obtain a current coded multimedia frame;
obtaining coding quality of the long-term reference frame;
calculating coding quality of the current coded multimedia frame;
determining a type of the current coded multimedia frame based on a motion vector corresponding to a coding block in the current coded multimedia frame;
updating the long-term reference frame based on the coding quality of the current coded multimedia frame, the type of the current coded multimedia frame, and the coding quality of the long-term reference frame; and
coding a subsequent multimedia frame in the multimedia data based on the updated long-term reference frame.

2. The method for coding multimedia data according to claim 1, wherein the calculating comprises:
calculating, based on a coding manner corresponding to the current coded multimedia frame, a target coding cost value of each coding block in the current coded multimedia frame;
calculating a target coding cost value of the current coded multimedia frame based on a statistical value of the target coding cost value of each coding block; and
determining the coding quality of the current coded multimedia frame based on the target coding cost value of the current coded multimedia frame,
wherein the target coding cost value of the current coded multimedia frame is in a negative correlation with the coding quality.

3. The method for coding multimedia data according to claim 2, wherein the calculating a target coding cost value comprises:
in a case that precoding is not performed on the current coded multimedia frame in a coding process, calculating the target coding cost value of the coding block based on an original coding cost value of the coding block; or
in a case that precoding is performed on the current coded multimedia frame in a coding process, calculating the target coding cost value of the coding block based on an original coding cost value of the coding block and a precoding cost value of the coding block.

4. The method for coding multimedia data according to claim 3, wherein the calculating the target coding cost value of the coding block based on an original coding cost value of the coding block comprises:
multiplying the original coding cost value of the coding block by a quantizer parameter associated with the coding block, to obtain the target coding cost value of the coding block.

5. The method for coding multimedia data according to claim 3, wherein the calculating the target coding cost value of the coding block based on an original coding cost value of the coding block and a precoding cost value of the coding block comprises:
multiplying the original coding cost value of the coding block by the quantizer parameter associated with the coding block, to obtain a candidate coding cost value of the coding block; and
performing weighted summation on the candidate coding cost value of the coding block and the precoding cost value of the coding block, to obtain the target coding cost value of the coding block,
wherein a weight of the candidate coding cost value is greater than a weight of the precoding cost value.

6. The method for coding multimedia data according to claim 1,
wherein the determining the type of the current coded multimedia frame comprises:
determining a target coding block in the current coded multimedia frame having a motion vector amplitude greater than a preset amplitude based on the motion vector corresponding to the coding block in the current coded multimedia frame; and
determining the type of the current coded multimedia frame based on a quantity of target coding blocks comprised in the current coded multimedia frame.

7. The method for coding multimedia data according to claim 6, wherein the determining the target coding block in the current coded multimedia frame comprises:
extracting, from the current coded multimedia frame, at least one candidate coding block coded based on an inter-frame prediction mode;
calculating an amplitude of a motion vector corresponding to the at least one candidate coding block; and
in a case that the amplitude of the motion vector corresponding to the candidate coding block is greater than the preset amplitude, determining that the at least one candidate coding block belongs to the target coding block.

8. The method for coding multimedia data according to claim 6, wherein the determining the type of the current coded multimedia frame comprises:
calculating a ratio of the quantity of target coding blocks in the current coded multimedia frame to a total quantity of coding blocks in the current coded multimedia frame;
in a case that the ratio is less than or equal to a preset threshold, determining the current coded multimedia frame as a static multimedia frame; or
in a case that the ratio is greater than a preset threshold, determining the current coded multimedia frame as a dynamic multimedia frame.

9. The method for coding multimedia data according to claim 1, wherein the updating the long-term reference frame comprises:
determining a next multimedia frame of the current coded multimedia frame as the updated long-term reference frame, in a case that the current coded multimedia frame is the static multimedia frame, and the coding quality of the current coded multimedia frame is higher than the coding quality of the long-term reference frame.

10. The method for coding multimedia data according to claim 1,
wherein the multimedia data comprises a plurality of multimedia frame groups,
wherein the updating comprises:
performing a zeroing operation on a quantity of current coded frames in a case that the quantity of current coded frames reaches a preset frame quantity;
updating the long-term reference frame based on the coding quality of the current coded multimedia frame, the type of the current coded multimedia frame, and the coding quality of the long-term reference frame,
wherein the preset frame quantity is an integer and less than a total quantity of multimedia frames in a multimedia frame group having the current multimedia frame, and
wherein the multimedia frame group belongs to the plurality of multimedia frame groups in the multimedia data.

11. The method for coding multimedia data according to claim 1, wherein the multimedia data comprises a plurality of multimedia frame groups; and
before the coding a current multimedia frame, the method further comprises:
determining a first frame in a multimedia frame group as the long-term reference frame during coding a multimedia frame in the multimedia frame group for the first time,
wherein the first frame is a key frame in the multimedia frame group.

12. The method for coding multimedia data according to claim 1, wherein the updating comprises:
obtaining a quality weight of the long-term reference frame based on a time interval between the current coded multimedia frame and the long-term reference frame in a case that the long-term reference frame is a key frame,
wherein the quality weight is in a negative correlation with the time interval;
generating target coding quality of the long-term reference frame based on the quality weight and the coding quality of the long-term reference frame,
wherein the target coding quality of the long-term reference frame is lower than the coding quality of the long-term reference frame; and
updating the long-term reference frame based on the coding quality of the current coded multimedia frame, the type of the current coded multimedia frame, and the target coding quality of the long-term reference frame.

13. The method for coding multimedia data according to claim 1, wherein the coding a current multimedia frame comprises:
obtaining a quantity of short-term reference frames based on a difference between a total quantity of reference frames corresponding to the multimedia data and a quantity of long-term reference frames;
determining, as the short-term reference frame, a coded multimedia frame preceding the current multimedia frame, and corresponding to the quantity of the short-term reference frames; and
coding the current multimedia frame based on the short-term reference frame and the long-term reference frame.

14. An apparatus for coding multimedia data, comprising:
at least one memory configured to store program code; and
at least one processor configured to read the program code and operate as instructed by the program code, the program code comprising:
coding code configured to cause at least one of the at least one processor to code a current multimedia frame in multimedia data based on a long-term reference frame corresponding to the current multimedia frame, to obtain a current coded multimedia frame;
obtaining code configured to cause at least one of the at least one processor to obtain coding quality of the long-term reference frame;
calculating code configured to cause at least one of the at least one processor to calculate coding quality of the current coded multimedia frame;
determining code configured to cause at least one of the at least one processor to determine a type of the current coded multimedia frame based on a motion vector corresponding to a coding block in the current coded multimedia frame;
updating code configured to cause at least one of the at least one processor to update the long-term reference frame based on the coding quality of the current coded multimedia frame, the type of the current coded multimedia frame, and the coding quality of the long-term reference frame; and
subsequent coding code configured to cause at least one of the at least one processor to code a subsequent multimedia frame in the multimedia data based on the updated long-term reference frame.

15. The apparatus for coding multimedia data according to claim 14, wherein the calculating code is further configured to cause at least one of the at least one processor to:
calculate, based on a coding manner corresponding to the current coded multimedia frame, a target coding cost value of each coding block in the current coded multimedia frame;
calculate a target coding cost value of the current coded multimedia frame based on a statistical value of the target coding cost value of each coding block; and
determine the coding quality of the current coded multimedia frame based on the target coding cost value of the current coded multimedia frame,
wherein the target coding cost value of the current coded multimedia frame is in a negative correlation with the coding quality.

16. The apparatus for coding multimedia data according to claim 15, wherein the calculating code is further configured to cause at least one of the at least one processor to:
in a case that precoding is not performed on the current coded multimedia frame in a coding process, calculate the target coding cost value of the coding block based on an original coding cost value of the coding block; or
in a case that precoding is performed on the current coded multimedia frame in a coding process, calculate the target coding cost value of the coding block based on an original coding cost value of the coding block and a precoding cost value of the coding block.

17. The apparatus for coding multimedia data according to claim 16, wherein the calculating code is further configured to cause at least one of the at least one processor to:
multiply the original coding cost value of the coding block by a quantizer parameter associated with the coding block, to obtain the target coding cost value of the coding block.

18. The apparatus for coding multimedia data according to claim 16, wherein the calculating code is further configured to cause at least one of the at least one processor to:
multiply the original coding cost value of the coding block by the quantizer parameter associated with the coding block, to obtain a candidate coding cost value of the coding block; and
perform weighted summation on the candidate coding cost value of the coding block and the precoding cost value of the coding block, to obtain the target coding cost value of the coding block,
wherein a weight of the candidate coding cost value is greater than a weight of the precoding cost value.

19. The apparatus for coding multimedia data according to claim 14,
wherein the determining code is further configured to cause at least one of the at least one processor to:
determine a target coding block in the current coded multimedia frame having a motion vector amplitude greater than a preset amplitude based on the motion vector corresponding to the coding block in the current coded multimedia frame; and
determine the type of the current coded multimedia frame based on a quantity of target coding blocks comprised in the current coded multimedia frame.

20. A non-transitory computer-readable storage medium, storing computer code which, when executed by at least one processor, causes the at least one processor to at least:
code a current multimedia frame in multimedia data based on a long-term reference frame corresponding to the current multimedia frame, to obtain a current coded multimedia frame;
obtain coding quality of the long-term reference frame;
calculate coding quality of the current coded multimedia frame;
determine a type of the current coded multimedia frame based on a motion vector corresponding to a coding block in the current coded multimedia frame;
update the long-term reference frame based on the coding quality of the current coded multimedia frame, the type of the current coded multimedia frame, and the coding quality of the long-term reference frame; and
code a subsequent multimedia frame in the multimedia data based on the updated long-term reference frame.
